(19) United States
(12) Patent Application Publication
(10) Pub. No.: US 2023/0288595 A1
(43) Pub. Date: Sep. 14, 2023

(54) Method and Apparatus for Cycle Skip Avoidance

(71) Applicant: BP Corporation North America Inc., Houston, TX (US)

(72) Inventors: Madhav VYAS, Houston, TX (US); John Theodore ETGEN, Houston, TX (US)

(73) Assignee: BP Corporation North America Inc., Houston, TX (US)

(21) Appl. No.: 18/178,693

(22) Filed: Mar. 6, 2023

Related U.S. Application Data
(60) Provisional application No. 63/317,641, filed on Mar. 8, 2022.

(51) Int. Cl. G01V 1/36; G01V 1/28

(52) U.S. Cl. CPC G01V 1/362; G01V 1/282; G01V 2210/679; G01V 2210/667

(57) ABSTRACT

Techniques to avoid a cycle skip in conjunction with a full waveform inversion are disclosed herein. A method includes selecting a first objective function of a full waveform inversion (FWI) from a set of objective functions, selecting a second objective function of the FWI from the set of objective functions, calculating a first misfit based upon the first objective function using modeled data with respect to observed data, calculating a first search direction based upon the first misfit between the modeled data and the observed data, calculating a second misfit based upon the second objective function using the modeled data with respect to the observed data, calculating a second search direction based upon the second misfit between the modeled data and the observed data, combining the first search direction with the second direction and computing an update to the modeled data based upon the first search direction and the second search direction combination.

### CROSS REFERENCE TO RELATED APPLICATIONS

This application is a non-provisional application claiming priority to U.S. provisional patent application No. 63/317,641 filed Mar. 8, 2022 and entitled “Method and Apparatus for Cycle Skip Avoidance,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to seismic data processing and/or subsurface modeling.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

In accordance with utilization of the seismic data, various techniques may be employed. Full Waveform Inversion (FWI) is one such technique whereby earth models are refined by reducing differences between recorded seismic data and modeled data. Thus, FWI attempts to estimate the properties of the subsurface (e.g., the model) by minimizing the misfit between the observed data and the modeled data. The seismic data are modeled using the physics of wave-propagation in conjunction with a current model. The misfits are fed back in to the inversion and the model is updated. This process is iterative and it continues until a satisfactory match between the modeled data and the observed data is reached.

A key component of the FWI process is the definition of the misfit between the modeled data and the observed data, which is also known as the objective function. The most commonly used objective function is the least-squares direct data misfit. For the least-squares direct data misfit, the inversion is driven to minimize the squared difference between the two data sets (i.e., the sum of the square of the sample-by sample subtraction of modeled and observed data). While this objective function is very intuitive and straightforward it is very sensitive to the choice of the starting model. For example, if the modeled data and the observed data are shifted by more than half-a-wavelength with respect to each other, the process of FWI driven by direct data misfit does not converge to the global minimum value. It is said to be trapped in a local minimum, where the FWI has inadvertently converged to a local minimum of the squared difference.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system;

FIG. 2 illustrates a marine survey system in a marine environment;

FIG. 3 illustrates a land survey system in a land environment;

FIG. 4 illustrates a computing system that may perform operations described herein based on data acquired via the marine survey system of FIG. 2 and/or the land survey system of FIG. 3;

FIG. 5 illustrates a flow diagram of an operation to carry out full waveform inversion (FWI) with cycle skip avoidance;

FIG. 6 illustrates a graphical representation of an example of an input data and modeled input data usable with FWI;

FIG. 7 illustrates a graphical representation of a first example of an objective function that can be assigned in conjunction with the flow diagram of FIG. 5;

FIG. 8 illustrates a graphical representation of a second example of a second objective function that can be assigned in conjunction with the flow diagram of FIG. 5;

FIG. 9 illustrates a graphical representation of a third example of a plurality of objective functions that can be assigned in conjunction with the flow diagram of FIG. 5; and

FIG. 10, illustrates a graphical representation corresponding to a stack of the third example of a plurality of objective functions of FIG. 9.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In an effort to reduce the incidences of Full Waveform Inversion (FWI) having direct data misfit that does not converge (i.e., being trapped in a local minima), different individual objective functions for FWI can be utilized to reduce any limitation of having a good starting model. Each of these objective functions pose the problem of inversion differently in order to avoid being trapped in a local minima. Although use of individual objective functions make the inversion somewhat less sensitive to the choice of starting model, the problem of local minima has not been eliminated.

Instead, different local minima that correspond to each of the different objective functions are present. The objective functions are each utilized in searching for the same answer, which is the global minima, and which does not change with the choice of an objective function. Accordingly, present techniques herein utilize not just selection of a particular objective functions in conjunction with a FWI, but rather utilize a combination of objective functions. Through the use of multiple different types of objective functions (or through the use of multiple variables in a particular type of objective function) the problem of realizing a local minima is greatly reduced and/or eliminated.

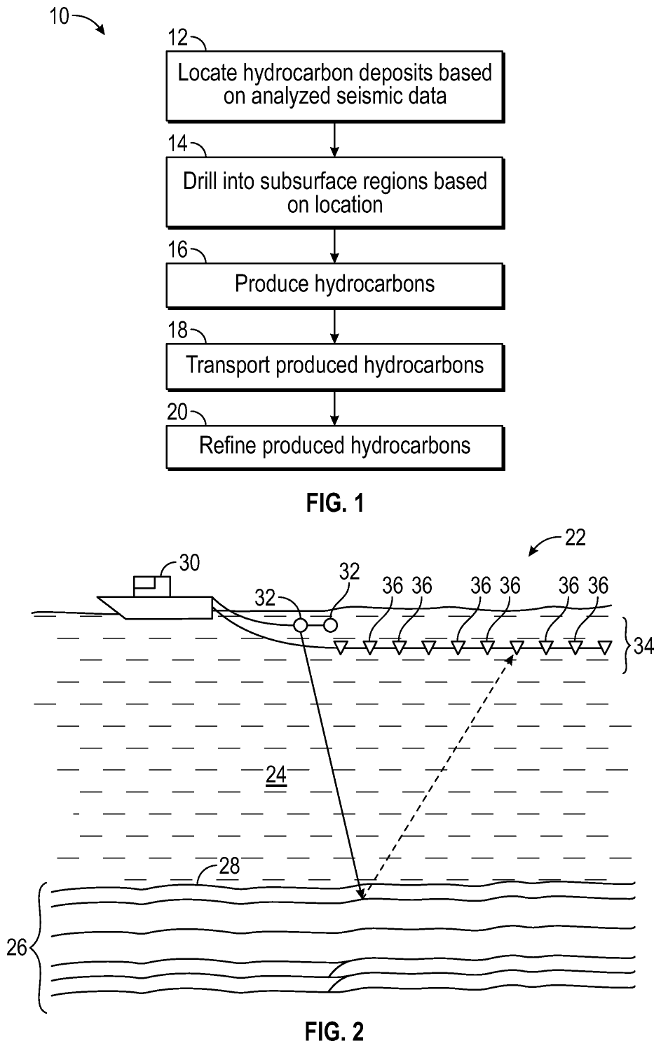

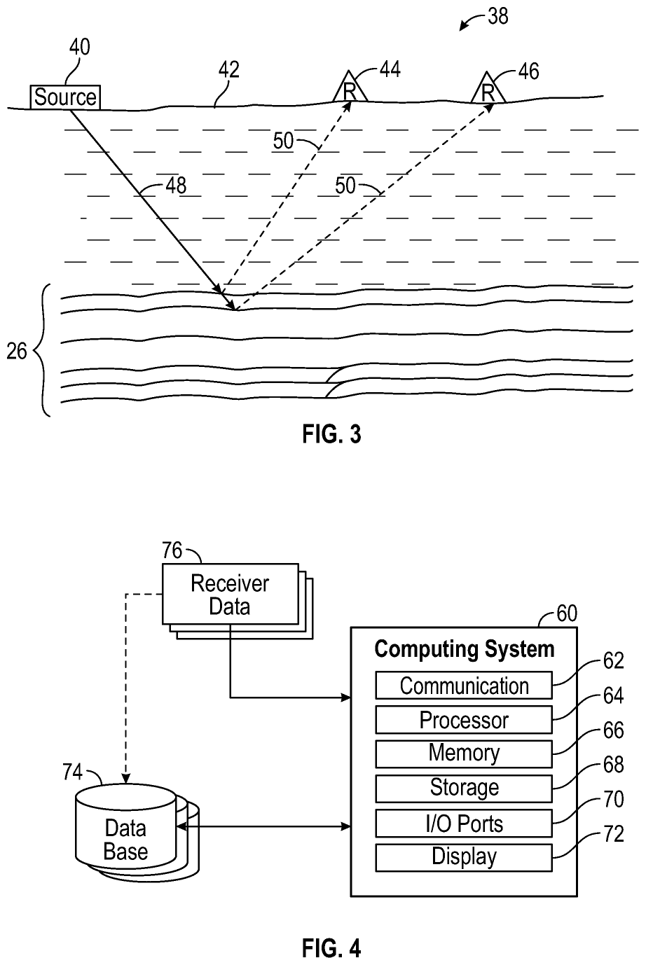

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code (e.g. instructions to cause the processor 64 to perform one or more operations). The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with one or more classifiers. With another embodiment, the classifier can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

FWI can be described as the process of finding a parameter that when wave propagation is simulated in that parameter model, a prediction of (i.e., a match of) the recorded data is generated. The objective function of the FWI can be a function of the observed data (received recorded seismic data) and simulated data (created from the model of the parameters selected).

As previously noted, one commonly used objective function utilized in conjunction with FWI is the least-squares direct data misfit. While this objective function is very intuitive and straightforward it is very sensitive to the choice of the starting model and if, for example, the modeled data and the observed data are shifted by more than half-a-wavelength with respect to each other, the process of FWI driven by direct data misfit does not converge. This can be referred to as a cycle skip (or cycle skipping) and causes erroneous model updates, which leads to incorrectly imaged seismic data. It can be represented by the FWI being trapped in a local minima.

An alternative is to maximize the correlation between the modeled and the observed data at zero-lag or in a narrow window around the zero lag. This is often referred to as the time-lag objective function. The time-lag objective function is less sensitive to the amplitude mismatch between the two waveforms, it instead measures the phase misfit. One possible formulation of the time-lag objective function is described below.

For time-lag FWI, it is desirable to maximize the zero-lag cross-correlation between the observed and the modeled data. Minimization of the negative of the correlation can be achieved at zero lag or in a narrow window around the zero lag. The aforesaid minimization problem can be stated as follows, where r(t)² is the value of a cross-correlation between the modeled data and the observed data at time t:

E=−½∫ₙ_{ₛ}∫ₙ_{ᵣ}∫ₙ_{ₜ}r(t)²dtdrds (Equation 1)

In the above Equation 1, r(t)² is defined as:

$$r ( t ) = {\int }_{{t}^{′} - {n}_{t}}^{{t}^{′} + {n}_{t}} W ( {t}^{′} ) {\int }_{{n}_{r}} W ( τ ) \frac{{d}_{0}^{n} ( {t}^{′} + τ ) {d}_{m}^{n} ( {t}^{′} )}{{d}_{m}^{n} {d}_{0}^{n}} d τ {dt}^{′} \qquad ( Equation 2 )$$

The gradient term for the time-lag FWI function that is used to update the model can be expressed as shown below:

$$E \frac{dE}{{dd}_{m}} = \qquad ( Equation 3 )$$

$${\int }_{{n}_{s}} {\int }_{{n}_{r}} {\int }_{{n}_{t}} r ( t ) [ {\int }_{{t}^{′} - {n}_{t}}^{{t}^{′} + {n}_{t}} W ( {t}^{′} ) [ {\int }_{{n}_{r}} nW ( τ ) \frac{{d}_{0}^{n} ( {t}^{′} + τ ) {d}_{m}^{n - 1} ( {t}^{′} )}{{d}_{m}^{n} {d}_{0}^{n}} d τ -$$

$$\frac{{nd}_{m} ( t )}{{d}_{m}^{2}} {\int }_{{n}_{r}} W ( τ ) \frac{{d}_{0}^{n} ( {t}^{′} + τ ) {d}_{m}^{n} ( {t}^{′} )}{{d}_{m}^{n} {d}_{0}^{n}} d τ ] {dt}^{′} ] dtdrds$$

The time-lag objective function is somewhat more robust, but for complex models it also has local minima. The local minima observed for the time-lag objective function as described above is a function of the number of lags used and also a function of the correlation window. Thus, even when utilizing the time-lag objective function, local minima can be realized, trapping the FWI operation resulting in production of a non-meaningful result.

Utilization of alternate objective functions can be undertaken. However, these alternate objective functions may also result in local minima, causing similar results to those discussed above (i.e., unreliable results). It should be noted that while alternate objective functions may also result in local minima, these local minima may differ amongst one another and may differ from the local minima from the time-lag objective function or may not experience a local minima at all. However, this introduces an issue of proper selection of the objective function to attempt to choose an objective function that will not result in local minima.

An alternative embodiment to choosing a particular objective function is described herein in which a plurality of objective functions may be selected and solved. Their outputs may thereafter be stacked to reduce the incidence of local minima and/or to allow the FWI to proceed to generation of an accurate result (i.e., a satisfactory match between the modeled data and the observed data is reached). This occurs because at the true solution, all of the plurality of objective functions are minimized. However, at false solutions, some of the plurality of objective functions are nearly minimized while others are not minimized (i.e., the plurality of objective functions do not share the same results). Only at the true solution are all of the plurality of objective functions minimized.

Thus, in contrast to a FWI having one objective function selected amongst the classes of possible objective functions (e.g., modeled data minus observed data squared, the time difference between the modeled data and the observed data, the cross correlation of the modeled data and the observed data, etc.) and being optimized, the present embodiment includes optimization of multiple objective functions simultaneously (e.g., computed in parallel with one another). By allowing for each objective function to generate a proposed update to the parameter model (e.g., an update to the model or a search vector in the space of possible models), there is a greater likelihood that the updates will lead the FWI to minimize a difference to the desired global-minimum value. For example, if near a local minimum of one objective function which is not the global minimum, then we will update in the wrong “direction” and the update will lead away from the desired solution. If, however, multiple different objective functions are combined (e.g., summed), they likely will not all point at the same suboptimal local minimum and the result we will more likely head towards the global minimum, thus reducing the chances of being trapped at a local minimum.

Thus, in some embodiments, leverage of the diversity of the local minima across different objective functions may be found by combining them. For example, in one embodiment, the combination may be the stack of the normalized gradients for each of a set of objective functions independently. The gradient represents the direction of movement of the FWI operation (i.e., towards a minima), which may also represent the slope of the objective function. When this is computed using a plurality of objective functions, and the gradients are summed (e.g., stacked), there is a reduced chance for trapping of the FWI operation in local false solutions (i.e., local minima).

The result is effective, as the failures that result in the independent objective functions settling in local minima are removed when the objective functions are combined. In other embodiments, other combinations are also possible, such as random selection of parameters and the objective function type.

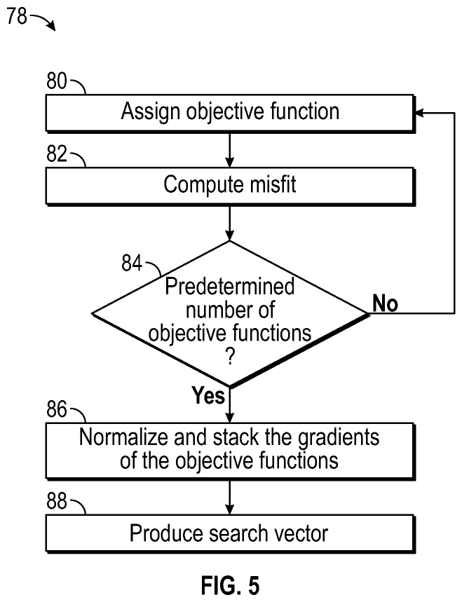

FIG. 5 illustrates a flow diagram 78 of an operation that will allow for FWI to be carried out with cycle skip avoidance. In step 80, an objective function is assigned. This objective function can be a function of the observed data (received recorded seismic data) and simulated data (created from the model of the parameters selected). Moreover, the assigned objective function can be of a type of objective functions that differs from other objective functions or the assigned objective function can be a single objective function with a first set of parameters (in contrast with that same objective function having a second set of parameters as a different objective function). Therefore, for example, step 80 may include assigning a single objective function with varied hyperparameters (e.g., varied parameters or varied adjustable parameters, such as window size, a number of lags in the correlation, etc.) as different objective functions, assigning objective functions that represent a different objective function types or classes as different objective functions, or may include assigning two or more different objective functions of different classes, whereby one or more of the two or more different objective functions have varied hyperparameters.

In step 82, a misfit is computed for the modeled trace (e.g., the simulated data). In some embodiments, this computation may include, for example, using a direct data difference objective function. In other embodiments, for example, the modeled trace is shifted and the misfit is computed in conjunction with step 82. In step 84, a determination is made if a predetermined number of objective functions have been assigned. This predetermined number may be two or more objective functions. For example, the predetermined number of objection functions may be approximately 5, 6, 7, 8, 9, 10, or another number if, for example, the objective functions represent a single objective function with varied variables. Likewise, for example, the predetermined number of objection functions may be approximately 2, 3, 4, 5, or another number if, for example, the objective functions represent a different objective function, i.e., different types or classes of objective functions.

If more objective functions are to be assigned, the process returns to step 80. If instead the predetermined number of objective functions have been assigned, the process continues to step 86 in which normalization and stacking of the gradients of the objective functions is undertaken. The normalization can operate to remove any information related to a magnitude (e.g., length) of the computed misfits for the objective functions while maintaining values of their direction, which is useful when applying a gradient decent technique during the FWI iteration process. This results in, as illustrated in step 88, production of a search vector using the normalized combination of the search directions. In this manner, the process illustrated by flow diagram 78 clarifies that the computed misfit leads to computation of a gradient (or search direction), which then leads to model and/or parameter updates. It should also be noted that in some embodiments, step 80 may be undertaken, then step 84 may be undertaken and this process may be repeated until the predetermined number of objective functions has been met. Thereafter, step 82 can be undertaken, followed by steps 86 and 88 thereafter.

Likewise, while it is described in step 86 that normalization and stacking of the gradients of the objective functions is undertaken, it should be understood that this is one technique of computing search directions and combining them and that other techniques using a predetermined combination technique (i.e., a preselected combination of the search directions, such as utilizing a geometric mean, an arithmetic mean, etc.) could be employed in place of the normalization and stacking of the gradients of the objective functions. That is, the present techniques allow for combination of the objective functions and their gradients generally, and one specific technique is illustrated in conjunction with step 86. More generally, the process described in conjunction with the flow diagram 78 can include computation of objective functions and gradients and performing combination of the objective functions and gradients (e.g., whereby the combination includes using a predetermined combinatorial technique, such as a geometric mean, an arithmetic mean, etc.).

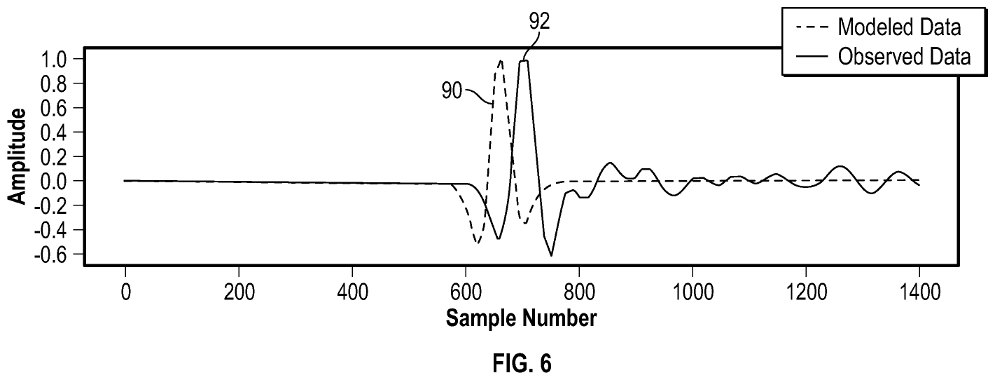

The concept behind the operation to carry out FWI with cycle skip avoidance as discussed above with respect to FIG. 5 can be illustrated, for example, using two traces. FIG. 6 illustrates a modeled trace 90 (e.g., modeled data) and an observed trace 2 (e.g., recorded seismic data). These traces 90 and 92 can be used to demonstrate the concept of stacking objective functions (as shown in FIG. 10). As can be seen in FIG. 6, the two traces are shifted with respect to each other.

The modeled trace 90 can be shifted around (as part of step 82 of FIG. 5) and the misfit can be computed (as part of step 82 of FIG. 5) using assigned objective functions (as part of step 80 of FIG. 5) whereby the assigned objective functions are different types of objective functions. For example, the modeled trace 90 can be shifted forward or backward in time. As discussed in greater detail below, this assignment will more clearly illustrate the problem of local minima.

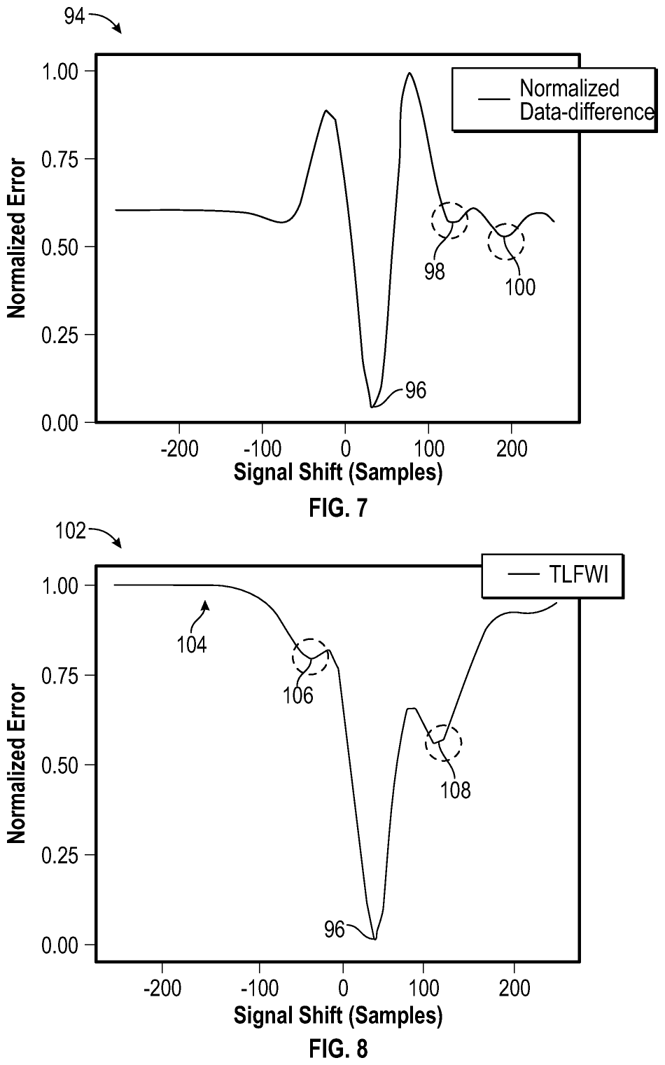

In one example, an assigned objective function may be a data difference objective function. FIG. 7 illustrates a graph 94 where the X-axis represents the number of samples by which the traces 90 and 92 of FIG. 6 are shifted (e.g., the signal shift) with respect to each other and the Y-axis represents the normalized misfit energy. As illustrated in the graph 94, the ideal answer, global minima 96 is located at approximately a 40 sample shift, which is where the misfit energy is truly minimum in a global sense. However, if the two signals are significantly shifted with respect to each other at the start, for instance at a shift of 200 samples, before the optimizer used in conjunction with the FWI can converge to the global minimum, it will go through a local minima 98 and/or local minima 100. Most optimizers used in conjunction with the FWI will stop upon reaching local minima 98 or 100 and will not progress beyond. In this scenario the process of iterative inversion is said to be trapped in a local minima. Being trapped in a local minima represents a gradient decent method in which the process, upon reaching a local minima, does not progress since any further calculations would yield a result that was less optimized than the result found in the local minima.

In another example, an assigned objective function may be a time-lag objective function. FIG. 8 illustrates a graph 102 illustrating a corresponding misfit plot 104 when the time-lag objective function is applied in conjunction with the traces 90 and 92. As illustrated in the graph 102, local minima 106 and 108 (although not as pronounced as local minima 98 and 100) are present. Additionally local minima 106 and 108 are in a different place in graph 102 versus local minima 98 and 100 of FIG. 7. Indeed, if the parameters used to compute the time-lag objective function are altered, the local minima 98 and 100 will move. However, the global minima 96 that corresponds to the true answer stays in place (e.g., at about 40 samples). This holds true for the data difference objective function of FIG. 7 as well.

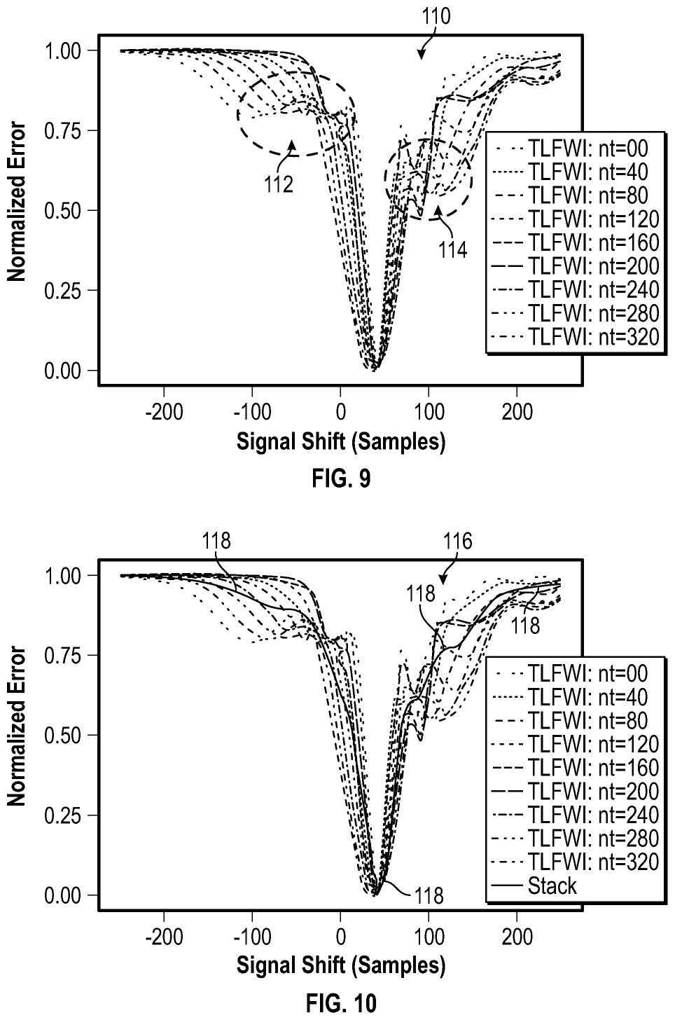

FIG. 9 illustrates a graph 110 with the time-lag objective function selected with the misfit energy calculated for several different choices of the time lag parameter as the parameter of the objective function being altered. The local minima 112 and 114 now span a range of shift values. Thus, FIG. 9 illustrated different objective functions (i.e., different based on their differing parameters applied to a time-lag objective function) as a function of different velocity models and at a true model, all of the objective functions are minimized (at global minima 96). Away from the true solution, some of the objective functions are minimizes, but many are not (i.e., represented by the local minima 112 and 114).

Each of the objective functions (e.g., the time-lag objective function having different parameters applied therein) can be normalized independently and then stacked (e.g., step 86 of FIG. 5). That is, if all of the objective functions from FIG. 9 are added together (i.e., computing the gradient may include summation of the gradients), there is an increased chance of avoiding the local minima 112 and 114. The result is illustrated in FIG. 10, which illustrates a graph 116 having a curve 118 which corresponds to the stack and, as illustrated, does not have any local minima. That is, curve does not have local valleys (i.e., local minima) in which the solution may get trapped and never progress to the true solution (i.e., global minima 96).

Therefore, taken together, FIGS. 7-9 illustrate that while each of the selected objective functions, whether they be different types of objective functions assigned from step 80 of FIG. 5 or the same function with different parameters assigned from step 80 of FIG. 5, generate include the true solution (e.g., global minima 96), each objective function also includes false solutions (e.g., local minima 98 and 100 or local minima 106 and 108), which can trap the inversion. However, by normalizing and stacking the plurality of selected objective functions, the global minima 96 (as illustrated by curve 118 in FIG. 10) can be generated. Additionally, in some embodiment, other modifications can be made, such as offset stepping, starting the inversion with lower frequencies etc. to reduce erroneous result generation. The process of stacking also has a benefit that the outcome becomes much less sensitive to the choice of parameters for any one single objective function. In other embodiments a workflow where objective functions are governed by completely different equations can be implemented, whereby progress is made at each iteration by using a combination.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
selecting a first objective function of a full waveform inversion (FWI) from a set of objective functions;
selecting a second objective function of the FWI from the set of objective functions;
calculating a first misfit based upon the first objective function using modeled data with respect to observed data, calculating a first search direction based upon the first misfit between the modeled data and the observed data;
calculating a second misfit based upon the second objective function using the modeled data with respect to the observed data, calculating a second search direction based upon the second misfit between the modeled data and the observed data; and
combining the first search direction with the second direction and computing an update to the modeled data based upon the first search direction and the second search direction combination.

2. The method of claim 1, wherein selecting the first objective function comprises selecting the first objective function from a first class of objective functions.

3. The method of claim 2, wherein the selecting the second objective function comprises selecting the second objective function from a second class of objective functions.

4. The method of claim 2, wherein the selecting the second objective function comprises selecting the second objective function from the first class of objective functions while having at least one different variable from the first objective function.

5. The method of claim 2, comprising calculating a third misfit based upon a third objective function using the modeled data with respect to the observed data, calculating a third search direction based upon the third misfit between the modeled data and the observed data, wherein the third misfit is calculated concurrently with the first misfit and the second misfit.

6. The method of claim 5, comprising combining the third search direction with the first search direction and the second direction to compute the update to the modeled data.

7. The method of claim 5, wherein the selecting the second objective function comprises selecting the second objective function from a second class of objective functions.

8. The method of claim 7, wherein the selecting the third objective function comprises selecting the third objective function from a third class of objective functions.

9. The method of claim 7, wherein the selecting the third objective function comprises selecting the third objective function from the first class of objective functions while having at least one different variable from the first objective function.

10. The method of claim 5, wherein the first misfit, the second misfit, and the third misfit are calculated concurrently through staggering calculation of one or more of the first misfit, the second misfit, and the third misfit.

11. A tangible and non-transitory machine readable medium, comprising instructions to cause a processor to:
select a first objective function of a full waveform inversion (FWI) from a set of objective functions;
select a second objective function of the FWI from the set of objective functions;
calculate a first misfit based upon the first objective function using modeled data with respect to observed data, calculate a first search direction based upon the first misfit between the modeled data and the observed data;
calculate a second misfit based upon the second objective function using the modeled data with respect to the observed data, calculate a second search direction based upon the second misfit between the modeled data and the observed data; and
combine the first search direction with the second direction and computing an update to the modeled data based upon the first search direction and the second search direction combination.

12. The tangible and non-transitory machine readable medium of claim 11, comprising instructions to cause the processor to select the first objective function from a first class of objective functions.

13. The tangible and non-transitory machine readable medium of claim 12, comprising instructions to cause the processor to select the second objective function from a second class of objective functions.

14. The tangible and non-transitory machine readable medium of claim 12, comprising instructions to cause the processor to select the second objective function from the first class of objective functions while having at least one different variable from the first objective function.

15. The tangible and non-transitory machine readable medium of claim 12, comprising instructions to cause the processor to calculate a third misfit based upon a third objective function using the modeled data with respect to the observed data, calculate a third search direction based upon the third misfit between the modeled data and the observed data, wherein the third misfit is calculated concurrently with the first misfit and the second misfit.

16. The tangible and non-transitory machine readable medium of claim 15, comprising instructions to cause the processor to combine the third search direction with the first search direction and the second direction to compute the update to the modeled data.

17. The tangible and non-transitory machine readable medium of claim 15, comprising instructions to cause the processor to select the second objective function from a second class of objective functions.

18. The tangible and non-transitory machine readable medium of claim 17, comprising instructions to cause the processor to select the third objective function from a third class of objective functions.

19. The tangible and non-transitory machine readable medium of claim 17, comprising instructions to cause the processor to select the third objective function from the first class of objective functions while having at least one different variable from the first objective function.

20. The tangible and non-transitory machine readable medium of claim 15, comprising instructions to cause the processor to concurrently calculate the first misfit, the second misfit, and the third misfit via staggering calculation of one or more of the first misfit, the second misfit, and the third misfit.
